(19) United States
(12) Patent Application Publication
(10) Pub. No.: US 2022/0180287 A1
(43) Pub. Date: Jun. 9, 2022

(54) OPTIMIZATION SUPPORT APPARATUS AND METHOD

(71) Applicant: Hitachi, Ltd., Tokyo (JP)

(72) Inventors: Kazuo MUTO, Tokyo (JP); Tatsuya HASEBE, Tokyo (JP)

(73) Assignee: Hitachi, Ltd., Tokyo (JP)

(21) Appl. No.: 17/482,905

(22) Filed: Sep. 23, 2021

(30) Foreign Application Priority Data
Dec. 7, 2020 (JP) 2020-202438

(51) Int. Cl. G06Q 10/06; G06Q 10/10; G06F 30/20; G06F 16/903

(52) U.S. Cl. CPC G06Q 10/06395; G06Q 10/101; G06F 2111/10; G06F 30/20; G06F 16/90335; G06Q 10/103

(57) ABSTRACT

There is provided an optimization support apparatus enabling it to reduce the number of runs of experiments or analysis and the cost therefor. The optimization support apparatus supports creating an experimental design to run experiments or numerical analysis for a project for optimizing design variables and includes a design solution preference storing unit that stores design solution preference data relevant to a target project for which design variables are optimized, the data representing a user decision about preference between design solutions; an experimental analysis results storing unit that stores experimental analysis results data regarding the target project; a preference model creating unit that creates a preference model, based on design solution preference data; a metamodel creating unit that creates a metamodel using a preference model and experimental analysis results data; and an experimental design creating unit that creates an experimental design using a metamodel created by the metamodel creating unit.

### CROSS-REFERENCE TO RELATED APPLICATION

This application claims priority to Japanese Patent Application No. 2020-202438 filed on Dec. 7, 2020, the entire contents of which are incorporated by reference herein.

### BACKGROUND OF THE INVENTION

The present invention relates to a technology to support designing products and a technology that efficiently optimizes design variables by experiments or numerical analysis.

In designing products, after specifying, inter alia, dimensions of components of a product as design variables, design optimization is performed to optimize the design variables so that the product will fulfill desired performance. A design optimization process iterates the following: assigning values to multiple design variables; creating a product for evaluation and creating an evaluation model for numerical analysis on a computer; and evaluating the product performance. However, if it costs high to create a product for evaluation and an evaluation model or run experiments or numerical analysis, it is impossible to make an evaluation with a large number of design variables. Therefore, it is required to seek for values of design variables that make a product fulfill desired performance efficiently.

Japanese Unexamined Patent Application Publication No. 2010-9595 proposes algorithms enabling reduction in the number of runs of experiments or numerical analysis in a design optimization process by optimizing an experimental design using a genetic algorithm.

### SUMMARY OF THE INVENTION

According to Japanese Unexamined Patent Application Publication No. 2010-9595, a metamodel is built based on results of experiments or analysis and experiments or analysis are iterated until the accuracy of the metamodel meets certain criteria. Supposing that this method is adopted, if there are a large number of design variables or if a product that is a subject for optimization exhibits a complicated physical phenomenon, a problem is posed in which experiments or numerical analysis need to be run a large number of times to create a metamodel that meets criteria.

One embodiment of the present invention resides in an optimization support apparatus that supports creating an experimental design to run experiments or numerical analysis for a project for optimizing design variables, the optimization support apparatus including: a project information storing unit that stores project information data including design variables for a project, a range of values of each of the design variables, an objective function, and the project purpose with respect to each project; a design solution preference storing unit that stores design solution preference data relevant to a target project for which design variables are optimized, the design solution preference data representing a user decision about preference between design solutions in which given values are assigned to design variables for the target project; an experimental analysis results storing unit that stores experimental analysis results data obtained when experiments or numerical analysis is run for the target project with given values assigned to design variables for the target project, the experimental analysis results data including the values assigned to the design variables and values of an objective function obtained through the experiments or numerical analysis; a preference model creating unit that creates a preference model, based on design solution preference data stored in the design solution preference storing unit; a metamodel creating unit that creates a metamodel using a preference model created by the preference model creating unit and experimental analysis results data stored in the experimental analysis results storing unit; and an experimental design creating unit that creates an experimental design using a metamodel created by the metamodel creating unit.

An optimization support apparatus and an optimization support method enabling it to reduce the number of runs of experiments or analysis and the cost therefor are provided.

Other problems and novel features will become apparent from the description herein and the accompanying drawings.

### BRIEF DESCRIPTION OF THE DRAWINGS

FIG. 1 is a diagram depicting a hardware structure of an optimization support apparatus;

FIG. 2 is a functional block diagram of an optimization support apparatus of a first embodiment;

FIG. 3A is an example of a data structure of design solution preference data (a design solution comparison table);

FIG. 3B is an example of a data structure of design solution preference data (a design solution design variables table);

FIG. 4 is an example of a data structure of experimental analysis results data;

FIG. 5 is a flowchart of an optimization support method of the first embodiment;

FIG. 6 is an example of what is displayed by an experimental design creating unit on an output device;

FIG. 7 is an example of an input screen for inputting preference between design solutions;

FIG. 8 is a functional block diagram of an optimization support apparatus of a second embodiment;

FIG. 9 is a flowchart of an optimization support method of the second embodiment;

FIG. 10 is an example of what is displayed by the experimental design creating unit on the output device;

FIG. 11 is a functional block diagram of an optimization support apparatus of a third embodiment;

FIG. 12A is an example of a data structure of project information data (a project table);

FIG. 12B is an example of a data structure of project information data (a design variables table);

FIG. 13 is a flowchart of an optimization support method of the third embodiment;

FIG. 14 is a diagram representing a true design variable and a metamodel in a comparative example;

FIG. 15A is a diagram representing a preference model according to an embodiment of the invention; and

FIG. 15B is a diagram representing a true design variable and a metamodel according to an embodiment of the invention.

### DETAILED DESCRIPTION OF THE PREFERRED EMBODIMENTS

Embodiments for carrying out the present invention are described with reference to the drawings, as appropriate.

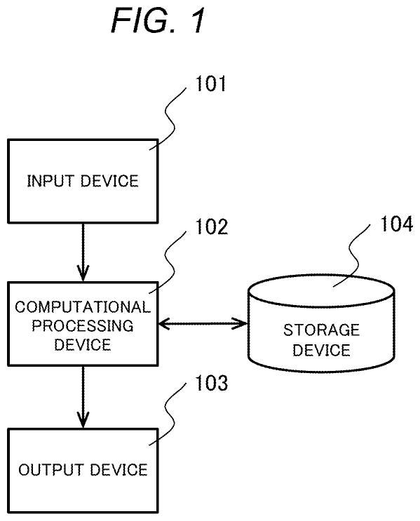

FIG. 1 depicts a hardware structure of an optimization support apparatus. The optimization support apparatus includes an input device 101, a computational processing device 102, an output device 103, and a storage device 104.

The input device 101 is input equipment such as a keyboard, a mouse, and a touch panel and is used for a user to input any data to the computational processing device 102. The computational processing device 102 is a CPU (Central Processing Unit) and performs information processing for optimization support. Programs that the CPU executes, their functions, or means for implementing the functions may be referred to as “functions”, “units”, or the like. The output device 103 is, e.g., a display device or the like and displays a screen for interactive processing between the user and the computational processing device 102. The storage device 104 is, e.g., a hard disk, a solid state drive, or the like and records results of processing by the computational processing device 102 or provides recorded results of processing to the computational processing device 102.

The optimization support apparatus may be connected with any other information processing apparatus via a network such as the Internet or intranet. In that case, data can be input from the other information processing apparatus and processing results can be output thereto instead of the input device 101 and the output device 103.

### First Embodiment

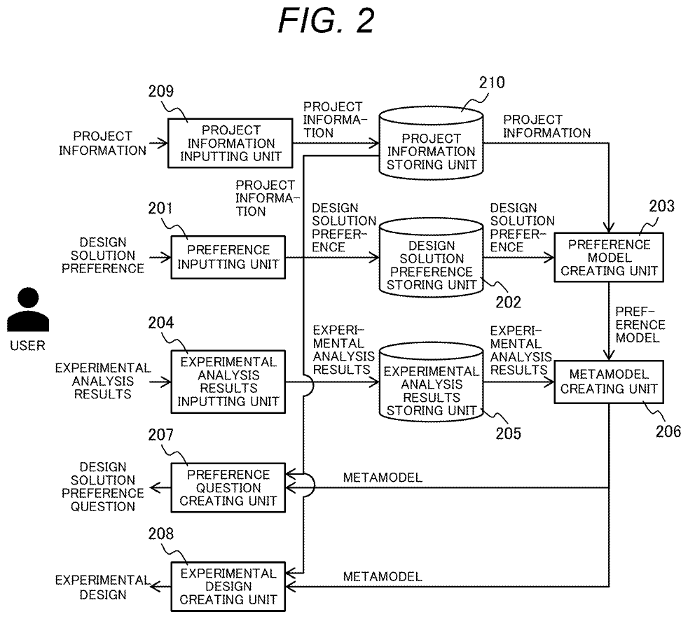

FIG. 2 is a functional block diagram of an optimization support apparatus of a first embodiment. The optimization support apparatus of the first embodiment includes the functions of the following: a preference inputting unit 201, a design solution preference storing unit 202, a preference model creating unit 203, an experimental analysis results inputting unit 204, an experimental analysis results storing unit 205, a metamodel creating unit 206, a preference question creating unit 207, an experimental design creating unit 208, a project information inputting unit 209, and a project information storing unit 210. The preference inputting unit 201, the preference model creating unit 203, the experimental analysis results inputting unit 204, the metamodel creating unit 206, the preference question creating unit 207, the experimental design creating unit 208, and the project information inputting unit 209 are run through the use of the computational processing device. Also, the design solution preference storing unit 202, the experimental analysis results storing unit 205, and the project information storing unit 210 are run through the use of the storage device 104.

The project information inputting unit 209 causes the project information storing unit 210 to store project information having been input via the input device 101. Iterating experiments or numerical analysis, while adjusting particular design variables repeatedly so that evaluation indexes of a product will meet requirements is herein referred to as a project. Project information is to include at least information about the name of a project, the identifiers of design variables, the ranges of values of the design variables, the identifier of an objective function, and the project purpose (maximizing or minimizing the objective function).

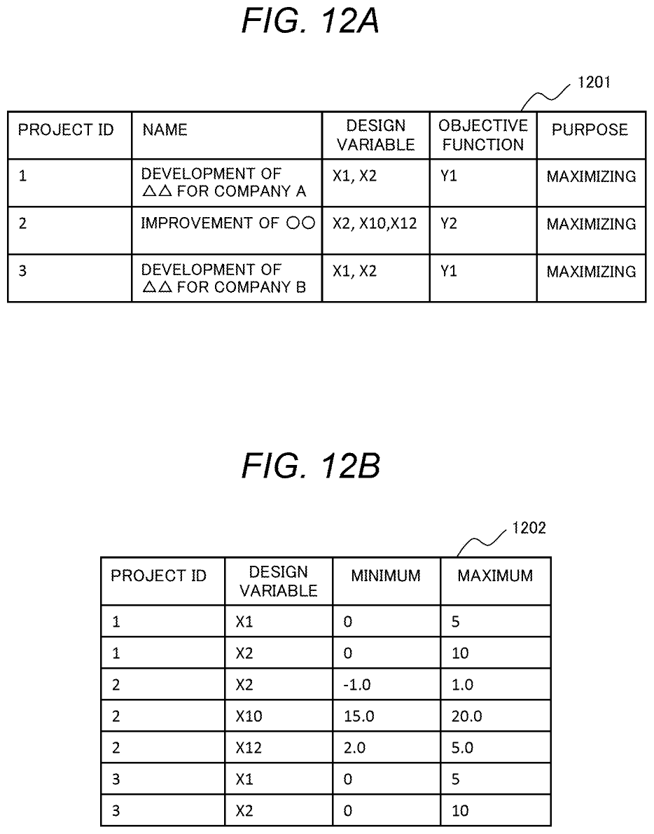

The project information storing unit 210 stores project information having been input from the project information inputting unit 209. FIGS. 12A and 12B exemplify pieces of project information data that are stored in the project information storing unit 210. In a project table 1201 (FIG. 12A), the following are recorded per project: the project name, the identifiers of design variables, the identifier of an objective function, and the project purpose. The following can be understood from the project table 1201: e.g., the name of a project with ID of “1” is “development of ΔΔ for Company A”; there are two design variables whose identifiers are X1 and X2 respectively; the objective function identifier is Y1; and the project purpose is maximizing the objective function. Note that a project may have multiple objective functions. In a design variables table 1202 (FIG. 12B), the minimum and maximum values of the design variables per project are stored. It is indicated that, for, e.g., a design variable X1 for a project with ID of “1”, its minimum value is 0 and its maximum value is 5.

The preference inputting unit 201 causes the design solution preference storing unit 202 to store design solution preference having been input via the input device 101. A design solution is a set of values of design variables representing the design solution. For a design problem, if the design is uniquely determined by design variables X1 and X2, a design solution is such that particular values are assigned to the design variables; e.g., it is assumed that X1=1.0 and X2=1.0. Design solution preference is information as to which is preferable between two design solutions when compared with respect to the objective function. For a design problem for which the design is uniquely determined by design variables X1 and X2 likewise, suppose that an objective function is Y and the project purpose is maximizing the value of Y. Then, if the objective function becomes Y=1.0 with a design solution A in which (X1, X2)=(1.0, 1.0), whereas the objective function becomes Y=1.2 with a design solution B in which (X1, X2)=(2.5, 1.2), design solution preference is information that “the design solution B is preferable to the design solution A”.

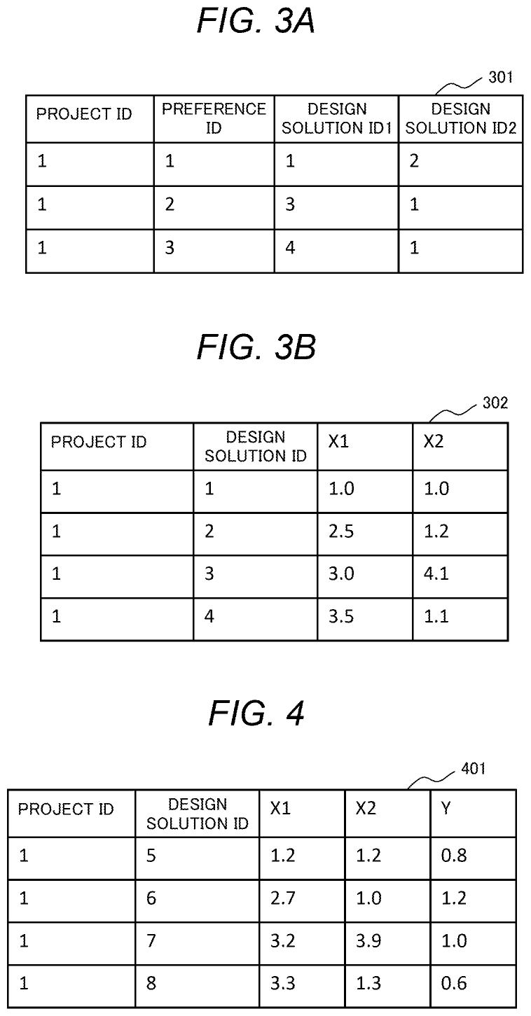

The design solution preference storing unit 202 stores design solution preference having been input from the preference inputting unit 201. FIGS. 3A and 3B exemplify pieces of design solution preference data that are stored in the design solution preference storing unit 202. In this example, the design solution preference storing unit 202 stores the pieces of design solution preference data in the forms of a design solution comparison table 301 (FIG. 3A) and a design solution design variables table 302 (FIG. 3B).

In the design solution comparison table 301 (FIG. 3A), as a result of comparison between two design solutions, the ID of a preferable design solution is stored in a design solution ID1 column and the ID of an unpreferable design solution is stored in a design solution ID2 column. For example, a record in which a project ID of “1” and a preference ID of “1” are specified indicates that a design solution with its ID of “1” is preferable to a design solution with its ID of “2”.

In the design solution design variables table 302 (FIG. 3B), values of design variables are stored with respect to each design solution ID. For example, a record in which a project ID of “1” and a design solution ID of “1” are specified indicates that values of design variables X1 and X2 are X1=1.0 and X2=1.0 for the design solution with its ID of “1”.

The preference model creating unit 203 creates a preference model, based on design solution preference data (FIGS. 3A and 3B) recorded in the design solution preference storing unit 202 and the project purpose in project information data (FIG. 12A) stored in the project information storing unit 210.

Here, a preference model is as follows: when any given value of a design variable is input to the model, the model outputs a score that is consistent with design solution preference data recorded in the design solution preference storing unit 202. For example, supposing that the project purpose is maximizing the objective function and information that a design solution B with a design variable X1=1.2 is preferable to a design solution A with the design variable X1=1.0 is given as design solution preference, the preference model outputs a smaller score when input is closer to X1=1.0 and a larger score when input is closer to X1=1.2.

The experimental analysis results inputting unit 204 causes the experimental analysis results storing unit 205 to store experimental analysis results having been input via the input device 101. Experimental analysis results are a set of associated data in which values of design variables are paired with a value of the objective function obtained through, inter alia, experiments or numerical analysis in relation to the values of the design variables. For example, such data is information as follows: when design variables are X1=1.0 and X2=1.0, the value of the objective function is Y=1.0.

FIG. 4 exemplifies pieces of experimental analysis results data stored in the experimental analysis results storing unit 205. In an experimental analysis results table 401 (FIG. 4), associated with, e.g., a design solution for which a project ID of “1” and a design solution ID of “5” are specified, it is indicated that the design variable X1 is 1.2, the design variable X2 is 1.2, and the value of the objective function Y obtained through experiments or numerical analysis is 0.8.

The metamodel creating unit 206 creates a metamodel from a preference model and experimental analysis results data. Here, a metamodel is as follows: any given value of a design variable is input to the model and the model predicts a value of the objective function in relation to the value of the design variable. If multiple objective functions are given for one project, metamodels are created for each objective function.

The preference question creating unit 207 creates a question about design solution preference, based on a metamodel and the value ranges of design variables for a project stored in the project information storing unit 210 and displays the question to the user via the output device 103. Here, a preference question is, e.g., a question asking which is preferable between a design solution A in which design variables X1 and X2 are X1=1.0 and X2=1.0 and a design solution B in which design variables X1 and X2 are X1=2.5 and X2=1.2.

The experimental design creating unit 208 creates an experimental design, based on a metamodel and the value ranges of design variables for a project stored in the project information storing unit 210 and displays the experimental design to the user via the output device 103. Here, an experimental design is a combination of values of design variables for which experiments or numerical analysis are to be run next.

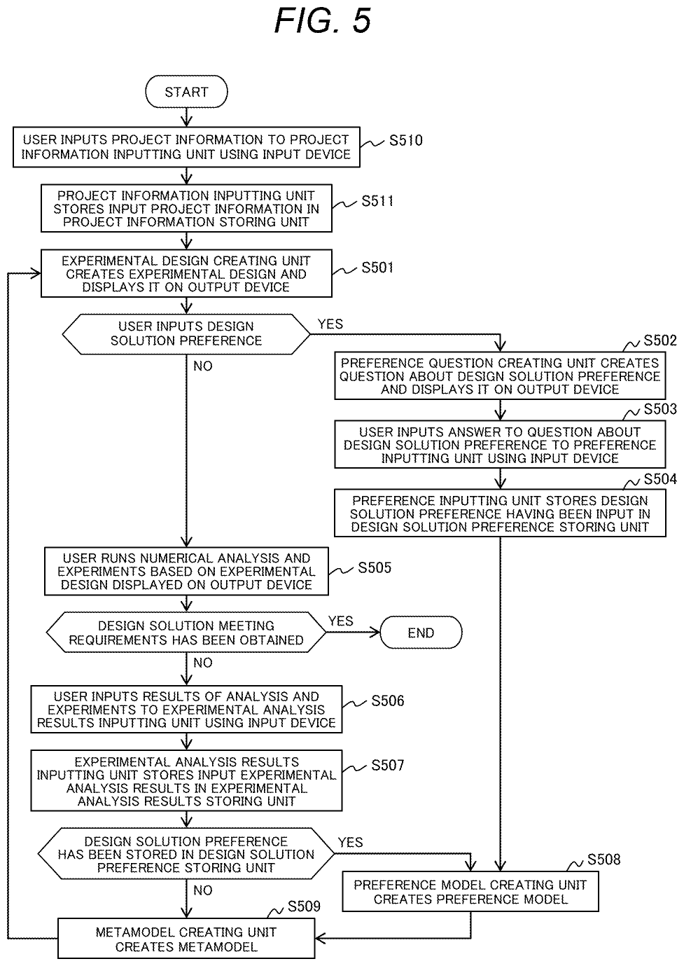

A processing flow of an optimization support method that is performed by the optimization support apparatus of the first embodiment is described with FIG. 5.

A user inputs project information to the project information inputting unit 209 using the input device 101 (S510). The project information inputting unit 209 stores the input project information in the project information storing unit 210 (S511).

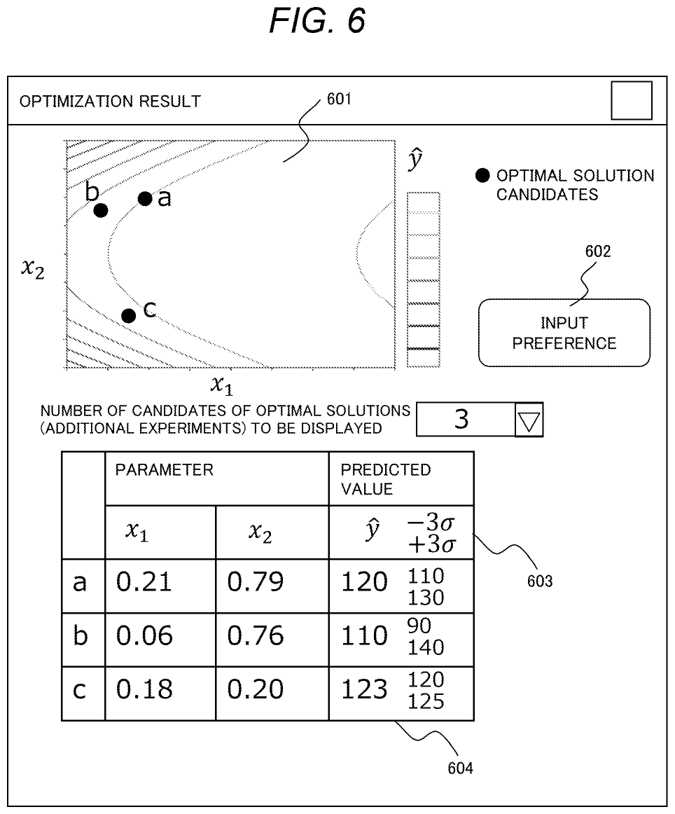

Then, the experimental design creating unit 208 displays an experimental design created, based on the value ranges of design variables specified in the project information having been input at step S510, on the output device 103 (S501). FIG. 6 illustrates an example of what is displayed on the output device 103. An experimental design created by the experimental design creating unit 208 is displayed in an experimental design tabular form 603. In this example, setting is made to display top three candidates. At this time, when an experimental design has been created using a metamodel which will be described later, results of predicting values of the objective function may be displayed in a predicted value column 604 and a relationship between design variables (x₁, x₂ which are given here) and the objective function (y which is given here) may be displayed with a contour diagram 601 or the like. As for an experimental design created before a metamodel is created, prediction results and the contour diagram are not displayed.

If experimental analysis results have not been stored in the experimental analysis results storing unit 205 and therefore no metamodel is created, the experimental design creating unit 208 can create an experimental design by utilizing, inter alia, an orthogonal table (Toshihiko Kawamura, “Seihin Kaihatsu. No Tame No Jikken Keikaku Ho: JMP Niyoru Oto Kyokumen Ho Computer Jikken”, Kind Ai kagaku sha Co., Ltd., 2018, pp. 63-72) or a Latin square (Thomas J. Santner, Brian J. Willians, William I. Notz, “The Design and Analysis of Computer Experiment”, Springer, 2003, pp. 122-161).

If experimental analysis results have been stored in the experimental analysis results storing unit 205 and there is a metamodel created at step S509 which will be described later, the experimental design creating unit 208 outputs the values of the design variables of multiple local optimal solutions that are obtained by optimizing the metamodel within the value ranges of the design variables for the project stored in the project information storing unit 210. Alternatively, the experimental design creating unit 208 calculates acquisition functions such as Expected Improvement, Probability of Improvement, and Upper Confidence Bound (Shahriari, Bobak, et al., “Taking the human out of the loop: A review of Bayesian optimization”, Proceedings of the IEEE 104.1 (2015): 148-175) and outputs multiple values of the design variables for which the acquisition function values are larger as an experimental design. When the project has multiple objective functions and thus multiple metamodels, the experimental design creating unit 208 calculates acquisition functions such as expected hypervolume improvement (Koji Shimoyama, Jeong Shinkyu, and Shigeru Obayashi, “Comparison of Sample Addition Criteria for Kriging Response Surface Models in Multi-Objective Optimization” Journal of The Japanese Society of Evolutionary Computation 3.3 (2012): 173-184) and outputs multiple values of the design variables for which the acquisition function values are larger as an experimental design.

When the user wants to start over the experimental design again for reasons such as that the experimental design displayed on the output device is not reasonable, the user may input design solution preference. In the displayed screen as illustrated in FIG. 6, for example, by clicking a design solution preference input button 602, a transition is made to a screen for inputting design solution preference.

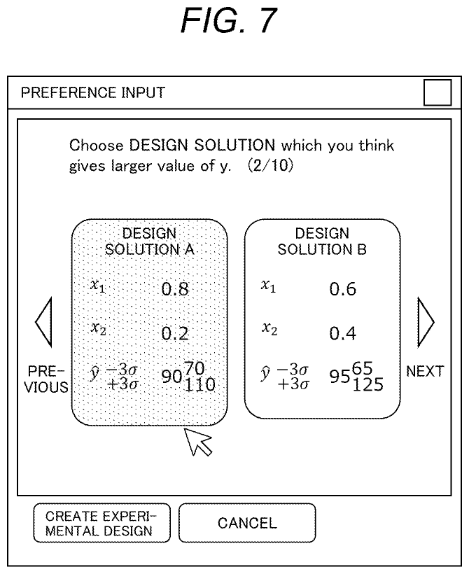

When the user has chosen to input design solution preference, the preference question creating unit 207 creates a question about design solution preference and displays the question on the output device 103 (S502). In response to this, the user inputs an answer to the question about design solution preference to the preference inputting unit 201 using the input device 101 (S503). FIG. 7 illustrates an example of what is displayed on the output device 103. In the example of FIG. 7, a pair of design solutions (design solutions A and B) is displayed for the user to choose which solution is preferable and the user should decide which is preferable. Specifically, if the project purpose is minimizing the objective function y, the user is prompted to choose a design solution that gives a smaller value of the objective function y by a user decision using the input device 101 such as the mouse. This screen is displayed for multiple pairs of design solutions and, for each pair, the user is prompted to choose a design solution which is regarded as preferable. Based on information having been input by the user, the preference inputting unit 201 creates design solution preference data (FIG. 3A) (S504). Note that, when a metamodel has already been created, inter alia, results of predicting values of the objective function may also be displayed when a pair of design solutions (design solutions A and B) is displayed.

If there is no metamodel, the preference question creating unit 207 creates design solutions to be displayed for the user to choose which solution is preferable by utilizing, inter alia, an orthogonal table (Toshihiko Kawamura, “Seihin Kaihatsu. No Tame No Jikken Keikaku Ho: JMP Niyoru Oto Kyokumen Ho Computer Jikken”, Kind Ai kagaku sha Co., Ltd., 2018, pp. 63-72) or a Latin square (Thomas J. Santner, Brian J. Willians, William I. Notz, “The Design and Analysis of Computer Experiment”, Springer, 2003, pp. 122-161). If experimental analysis results have been stored in the experimental analysis results storing unit 205 and there is a metamodel, as design solutions to be displayed for the user to choose which solution is preferable, a selection is made of design solutions in relation to the values of design variables of multiple local optimal solutions that are obtained by optimizing the metamodel within the value ranges of the design variables for the project stored in the project information storing unit 210. Alternatively, a calculation is made of acquisition functions such as Expected Improvement, Probability of Improvement, and Upper Confidence Bound (Shahriari, Bobak, et al., “Taking the human out of the loop: A review of Bayesian optimization”, Proceedings of the IEEE 104.1 (2015): 148-175). Design solutions in relation to multiple values of the design variables for which the acquisition function values are larger are selected to be displayed.

Then, the preference model creating unit 203 creates a preference model (S508), based on design solution preference data recorded in the design solution preference storing unit 202. Creating a preference model can be executed by utilizing, inter alia, Preference Learning described in, e.g., Wei Chu, Zoubin Ghahramani, “Preference Learning with Gaussian Processes”, Proceedings of the 22nd international conference on Machine Learning, 2005.

Then, the metamodel creating unit 206 creates a metamodel (S509), based on experimental analysis results data recorded in the experimental analysis results storing unit 205 and the preference model. Creating a metamodel can be executed by utilizing, inter alia, co-kriging described in, e.g., Forrester, Alexander I J, Andras Sobester, and Andy J. Keane, “Multi-fidelity optimization via surrogate modeling”, Proceedings of the royal society a: mathematical, physical and engineering sciences 463.2088 (2007): 3251-3269.

After that, the experimental design creating unit 208 creates an experimental design again, based on the metamodel and the value ranges of design variables for the project stored in the project information storing unit 210 and displays the experimental design on the output device (S501).

If the user has not input design solution preference, i.e., if the user is satisfied with the presented experimental design, the user runs numerical analysis or experiments based on the experimental design displayed on the output device to derive values of the objective function (S505). Once a design solution in which the objective function values meet requirements such as a design target value has been obtained through the numerical analysis or experiments, the project terminates.

If not so, the user inputs results of the experiments or analysis to the experimental analysis results inputting unit 204 using the input device 101 (S506). The experimental analysis results inputting unit 204 causes the experimental analysis results storing unit 205 to store the input results of the experiments or analysis (S507).

If design solution preference has been stored in the design solution preference storing unit 202, the preference model creating unit 203 creates a preference model (S508). The metamodel creating unit 206 creates a metamodel (S509), based on the preference model and experimental analysis results data stored in the experimental analysis results storing unit 205. Otherwise, if design solution preference has not been stored in the design solution preference storing unit 202, the metamodel creating unit 206 creates a metamodel by utilizing, e.g., Gaussian Process Regression or like algorithms, based on experimental analysis results data stored in the experimental analysis results storing unit 205 (S509).

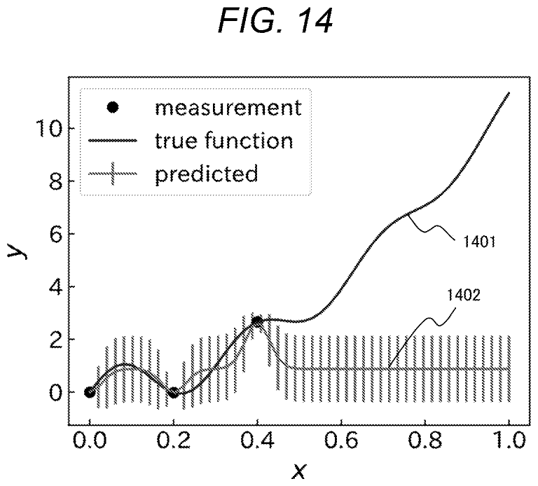

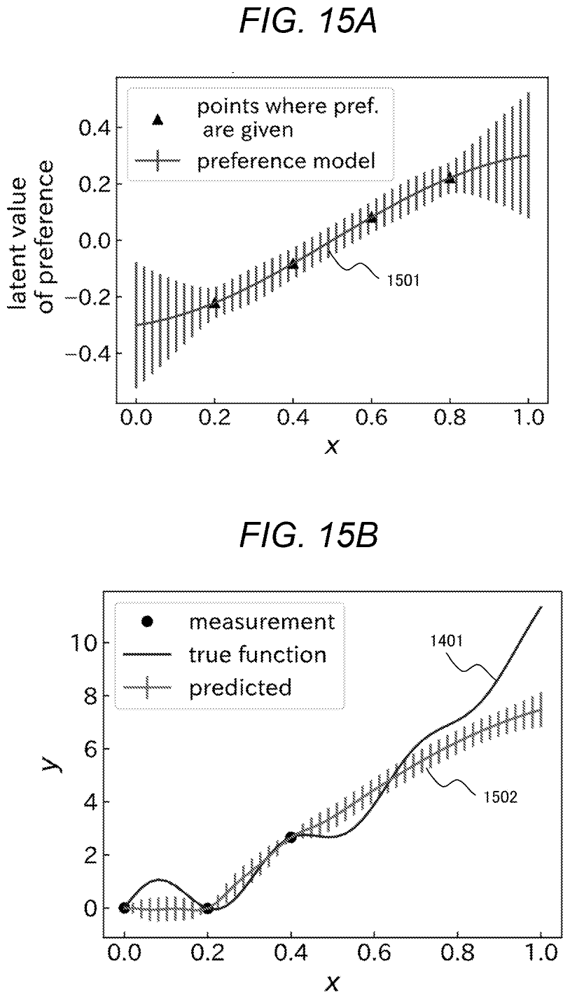

Advantageous effects of the present embodiment are described with FIG. 14 and FIGS. 15A and 15B. FIG. 14 illustrates a comparative example in which a metamodel is created to predict values of an objective function y from a design variable x only from experimental analysis results. The abscissa of the graph plots values of the design variable x and the ordinate plots values of the objective function y. Values of the objective function y obtained from actual experimental analysis results are represented by black dots and the waveforms of a true objective function 1401 and the metamodel 1402 are presented respectively. The abscissa range corresponds to a range of values of the design variable for a project. In a range where experimental analysis results are available, the waveforms of the true objective function 1401 and the metamodel 1402 can be expected to approximate to each other. However, in a region where experimental analysis results are not available, it is likely that the metamodel 1402 deviates greatly from the true objective function 1401, as in FIG. 14. In such a case, even by prediction of a next measurement point using the metamodel 1402, it is very difficult to select a measurement point that gives useful information for approximating the metamodel to the true objective function.

In the present embodiment, even if available experimental analysis results are only limited in contrast to the range of values of a design variable for a project, a preference model 1501 is created based on the user's knowledge over the range of values of the design variable for a product (FIG. 15A). In FIG. 15A, design solutions about which the preference question creating unit 207 asked a question to the user are marked with a black triangle. The metamodel creating unit 206 creates a metamodel using the preference model 1501 and experimental analysis results data. Thereby, it is possible to obtain the metamodel 1502 that is more approximate to the waveform of the true objective function 1401 over the entire range of values of the design variable for a project, as presented in FIG. 15B. By prediction of a next measurement point using the metamodel 1502, it becomes more likely that a measurement point can be selected that gives useful information for further approximating the metamodel to the true objective function.

Furthermore, when creating a preference model, it is also regarded as important that a question format such as “which design solution you think desirable?” is adopted to make it easy to bring out the user's knowledge. For example, given that such a question is directly asked to the user that “what waveform of an objective function should be over the range of values of a design variable for a project?” With an increase in the number of design variables for the project, it will be hard for the user to predict the waveform of a true objective function properly. Nevertheless, comparing between particular design solutions and integrating fragmentary pieces of knowledge eventually enable it to create a preference model that is approximate to the waveform of a true objective function.

Embodiments that will be described hereinafter also have the advantageous effects as noted above.

### Second Embodiment

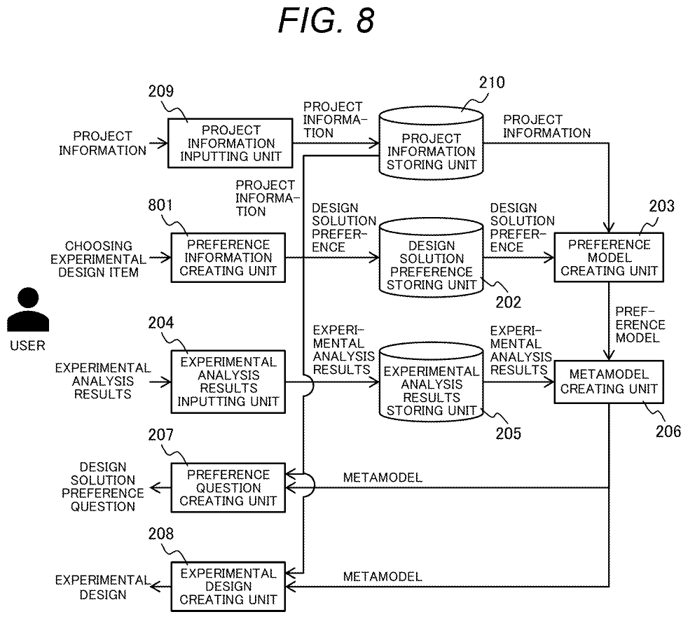

FIG. 8 is a functional block diagram of an optimization support apparatus of a second embodiment. Note that a hardware structure is that depicted in FIG. 1, as is the case for the first embodiment. The optimization support apparatus of the second embodiment includes the functions of the following: a preference information creating unit 801, a design solution preference storing unit 202, a preference model creating unit 203, an experimental analysis results inputting unit 204, an experimental analysis results storing unit 205, a metamodel creating unit 206, a preference question creating unit 207, an experimental design creating unit 208, a project information inputting unit 209, and a project information storing unit 210. The preference information creating unit 801, the preference model creating unit 203, the experimental analysis results inputting unit 204, the metamodel creating unit 206, the preference question creating unit 207, the experimental design creating unit 208, and the project information inputting unit 209 are run through the use of the computational processing device 102. Also, the design solution preference storing unit 202, the experimental analysis results storing unit 205, and the project information storing unit 210 are run through the use of the storage device 104.

Descriptions are provided below about the functional block diagram for the second embodiment. However, in the functional block diagram depicted in FIG. 8, for components having the same functions as those of the already described components depicted in the functional block diagram of FIG. 2 and assigned identical reference designators, their duplicated description is omitted.

The preference information creating unit 801 creates information about design solution preference from a user choice on an experimental design having been input via the input device 101 and stores that information in the design solution preference storing unit 202. In other words, this unit extracts design solution preference from information as to which design solution, i.e., which combination of the values of design variables has been chosen by the user from within an experimental design created by the experimental design creating unit 208. For example, suppose that what is displayed on the output device 103 by the experimental design creating unit 208 is a design solution A in which design variables X1 and X2 are X1=1.0 and X2=1.0 and a design solution B in which design variables X1 and X2 are X1=2.5 and X2=1.2 and the user chose the design solution A as a combination of the values of the design variables by which experiments or numerical analysis are to be run. In that case, the preference information creating unit 801 extracts design solution preference in which the design solution A is preferable to the design solution B and stores the design solution preference in the design solution preference storing unit 202.

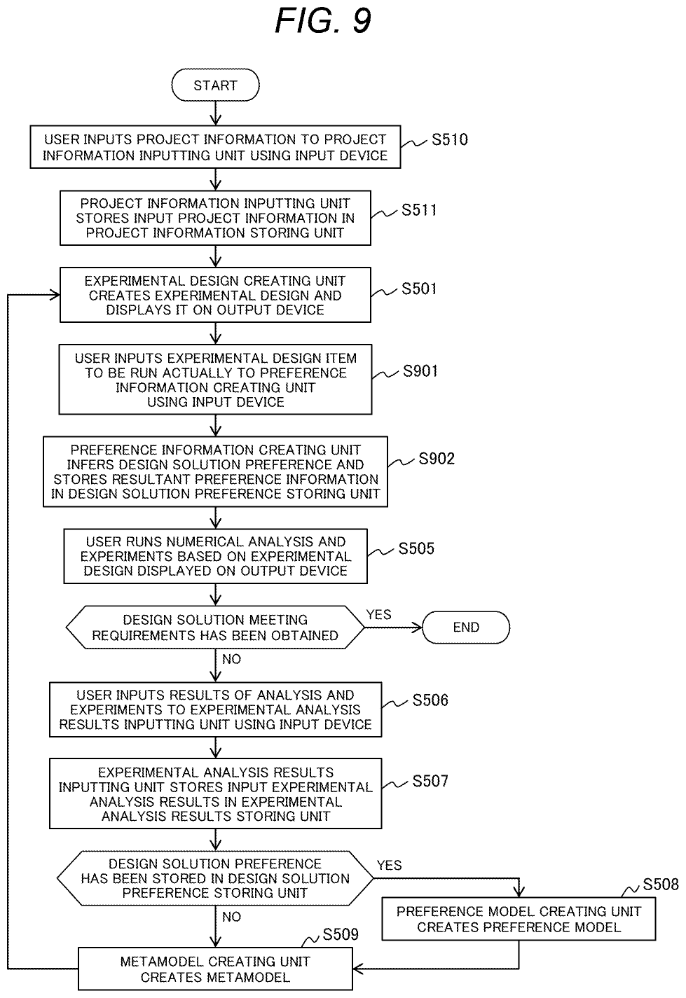

A processing flow of an optimization support method that is performed by the optimization support apparatus of the second embodiment is described with FIG. 9. Note that, in the flowchart illustrated in FIG. 9, for processing steps corresponding to the already described steps illustrated in FIG. 5 and assigned identical reference designators, their duplicated description is omitted.

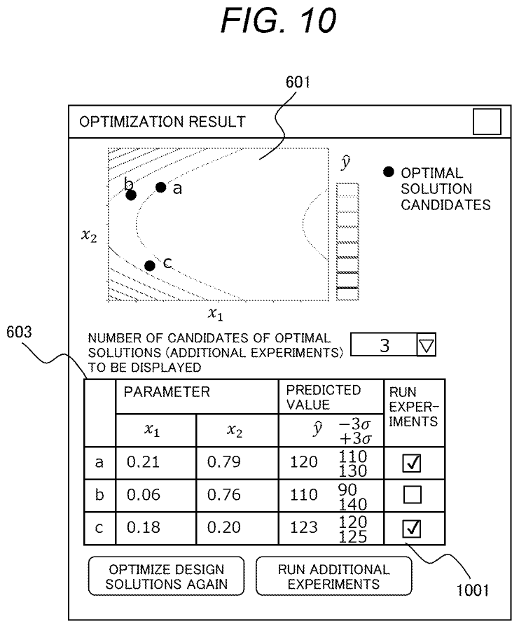

The user chooses an experimental design item to be run actually using the input device 101 and inputs it to the preference information creating unit 801 using the input device 101 (S901). FIG. 10 illustrates an example of a screen for choosing an experimental design item. In FIG. 10, by checking a checkbox 1001, the user may choose which design solution, i.e., which combination of the values of design variables by which experiments or numerical analysis are to be run from within an experimental design presented by the experimental design creating unit 208.

Next, based on information as to which design solution item is chosen by the user at step S901, the preference information creating unit 80 infers design solution preference and stores resultant preference information in the design solution preference storing unit 202 (S902). For example, if design solutions a and c are chosen, but a design solution b is not chosen, as in FIG. 10, the preference information creating unit 80 can extract two pieces of design solution preference information: i.e., the design solution a is preferable to the design solution b; and the design solution c is preferable to the design solution b. This unit stores these pieces of preference information in the design solution preference storing unit 202.

### Third Embodiment

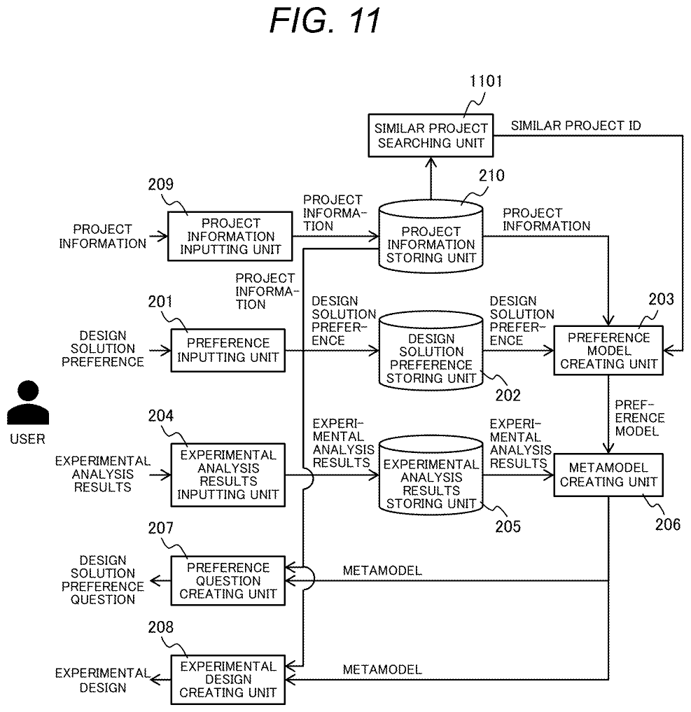

FIG. 11 is a functional block diagram of an optimization support apparatus of a third embodiment. Note that a hardware structure is that depicted in FIG. 1, as is the case for the first embodiment. The optimization support apparatus of the third embodiment includes the functions of the following: a preference inputting unit 201, a design solution preference storing unit 202, a preference model creating unit 203, an experimental analysis results inputting unit 204, an experimental analysis results storing unit 205, a metamodel creating unit 206, a preference question creating unit 207, an experimental design creating unit 208, a project information inputting unit 209, a project information storing unit 210, and a similar project searching unit 1101. The preference inputting unit 201, the preference model creating unit 203, the experimental analysis results inputting unit 204, the metamodel creating unit 206, the preference question creating unit 207, the experimental design creating unit 208, the project information inputting unit 209, and the similar project searching unit 1101 are run through the use of the computational processing device 102. Also, the design solution preference storing unit 202, the experimental analysis results storing unit 205, and the project information storing unit 210 are run through the use of the storage device 104.

Descriptions are provided below about the functional block diagram for the second third. However, in the functional block diagram depicted in FIG. 11, for components having the same functions as those of the already described components depicted in the functional block diagram of FIG. 2 and assigned identical reference numerals, their duplicated description is omitted.

The similar project searching unit 1101 compares information on a target project for experiments or analysis having been input from the project information inputting unit 209 with project information stored in the project information storing unit 210, searches for a previous project similar to the target project for experiments or analysis, and outputs the ID of such project as a similar project ID. For example, in FIG. 12A, when information on a project with its ID of “3” has been input, this unit outputs a project ID of “1” as a similar project ID, since design variables and an objective function specified for both projects are the same. Note that similarity judgment is not limited to a specific way. Even if design variables and an objective function specified for both projects are not the same completely, a project that is provided with design variables including design variables specified for the target project for experiments or analysis may be judged as a similar project. In terms of a range of values of a design variable, if the ranges specified for a previous project and the target project overlap even though they are not completely the same, the previous project may be judged as a similar project.

Furthermore, the preference model creating unit 203 creates a preference model, based on design solution preference recorded in the design solution preference storing unit 202 and, when doing so, it creates a preference model additionally using design solution preference recorded with regard to a similar project.

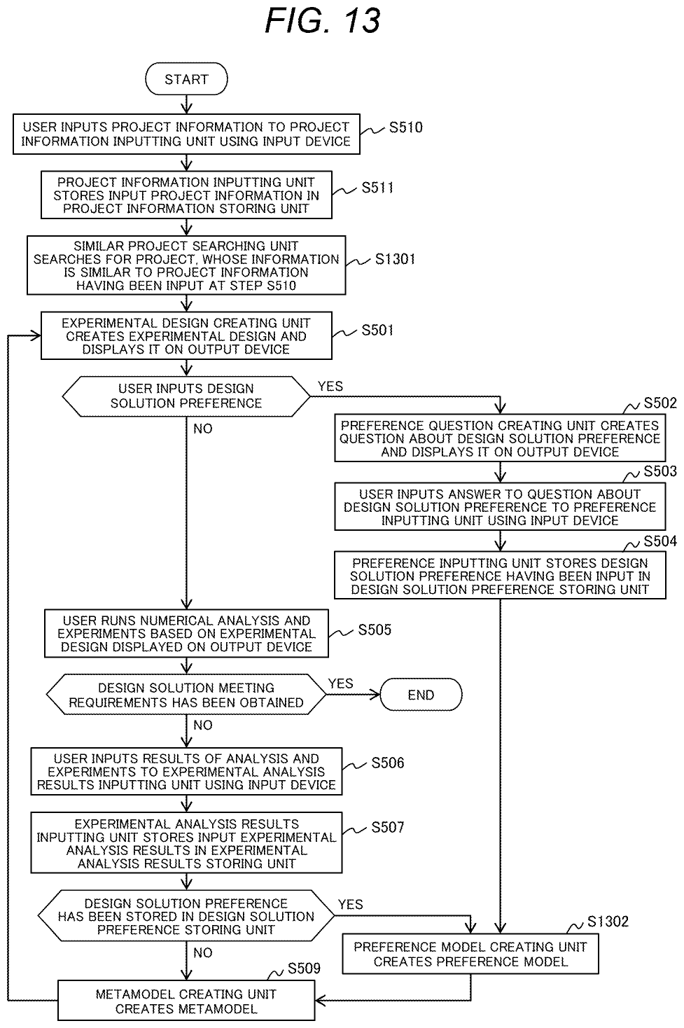

A processing flow of an optimization support method that is performed by the optimization support apparatus of the third embodiment is described with FIG. 13. Note that, in the flowchart illustrated in FIG. 13, for processing steps corresponding to the already described steps illustrated in FIG. 5 and assigned identical reference designators, their duplicated description is omitted.

The similar project searching unit 1101 searches for a project, whose information is similar to project information having been input at step S510, and outputs the ID of such project as a similar project ID (S1301).

In addition, the preference model creating unit 203 creates a preference model, based on design solution preference recorded in the design solution preference storing unit 202 (S1302). When doing so, the preference model creating unit 203 creates a preference model, using not only design solution preference with regard to a target project for experiments or analysis but also design solution preference with regard to a project identified as a similar project.

### REFERENCE SIGNS LIST

101: input device, 102: computational processing device, 103: output device, 104: storage device, 201: preference inputting unit, 202: design solution preference storing unit, 203: preference model creating unit, 204: experimental analysis results inputting unit, 205: experimental analysis results storing unit, 206: metamodel creating unit, 207: preference question creating unit, 208: experimental design creating unit, 209: project information inputting unit, 210: project information storing unit, 301: design solution comparison table, 302: design solution design variables table, 401: experimental analysis results table, 601: contour diagram, 602: design solution preference input button, 603: experimental design tabular form, 604: predicted value column, 801: preference information creating unit, 1001: checkbox, 1101: similar project searching unit, 1201: project table, 1202: design variables table, 1401: true objective function, 1402, 1502: metamodel, 1501: preference model.

What is claimed is:

1. An optimization support apparatus that supports creating an experimental design to run experiments or numerical analysis for a project for optimizing design variables, the optimization support apparatus comprising:
a project information storing unit that stores project information data including design variables for a project, a range of values of each of the design variables, an objective function, and a project purpose with respect to each project;
a design solution preference storing unit that stores design solution preference data relevant to a target project for which design variables are optimized, the design solution preference data representing a user decision about preference between design solutions in which given values are assigned to design variables for the target project;
an experimental analysis results storing unit that stores experimental analysis results data obtained when experiments or numerical analysis is run for the target project with given values assigned to design variables for the target project, the experimental analysis results data including the values assigned to the design variables and values of an objective function obtained through the experiments or numerical analysis;
a preference model creating unit that creates a preference model, based on design solution preference data stored in the design solution preference storing unit;
a metamodel creating unit that creates a metamodel using a preference model created by the preference model creating unit and experimental analysis results data stored in the experimental analysis results storing unit; and
an experimental design creating unit that creates an experimental design using a metamodel created by the metamodel creating unit.

2. The optimization support apparatus according to claim 1, further comprising:
a preference question creating unit that creates multiple pairs of design solutions regarding the target project and presents them to a user; and
a preference inputting unit that accepts a user decision about preference between the multiple pairs of design solutions presented by the preference question creating unit from the user.

3. The optimization support apparatus according to claim 2, wherein the preference question creating unit creates the multiple pairs of design solutions using a metamodel created by the metamodel creating unit.

4. The optimization support apparatus according to claim 1, further comprising a preference information creating unit that extracts a user decision about preference between design solutions, based on an experimental design item by which the user has actually run experiments or numerical analysis, chosen from multiple items of experimental design created by the experimental design creating unit.

5. The optimization support apparatus according to claim 4, wherein, as for multiple items of experimental design created by the experimental design creating unit, the preference information creating unit decides that a design solution corresponding to an experimental design item by which the user has actually run experiments or numerical analysis is preferable to a design solution corresponding to an experimental design item by which the user has not actually run experiments or numerical analysis.

6. The optimization support apparatus according to claim 1, further comprising a similar project searching unit that searches for a similar project that is similar to the target project from project information data stored in the project information storing unit,
wherein the preference model creating unit creates a preference model, based on design solution preference data specific to the target project and the similar project, stored in the design solution preference storing unit.

7. The optimization support apparatus according to claim 6, wherein the similar project searching unit judges similarity between projects, based on design variables and an objective function specified in project information data stored in the project information storing unit.

8. The optimization support apparatus according to claim 1, wherein the project purpose is defined as maximizing or minimizing an objective function in project information data stored in the project information storing unit.

9. An optimization support method using an optimization support apparatus that supports creating an experimental design to run experiments or numerical analysis for a project for optimizing design variables,
wherein the optimization support apparatus includes a project information storing unit that stores project information data including design variables for a project, a range of values of each of the design variables, an objective function, and a project purpose with respect to each project; a design solution preference storing unit that stores design solution preference data relevant to a target project for which design variables are optimized, the design solution preference data representing a user decision about preference between design solutions in which given values are assigned to design variables for the target project; and an experimental analysis results storing unit that stores experimental analysis results data obtained when experiments or numerical analysis is run for the target project with given values assigned to design variables for the target project, the experimental analysis results data including the values assigned to the design variables and values of an objective function obtained through the experiments or numerical analysis,
the optimization support method comprising the steps of:
creating a preference model, based on design solution preference data stored in the design solution preference storing unit;
creating a metamodel using a preference model created and experimental analysis results data stored in the experimental analysis results storing unit; and
creating an experimental design using a metamodel created.

10. The optimization support method according to claim 9, further comprising the steps of:
creating multiple pairs of design solutions regarding the target project and presenting them to a user; and
accepting a user decision about preference between the thus presented multiple pairs of design solutions from the user.

11. The optimization support method according to claim 9, further comprising the step of extracting a user decision about preference between design solutions, based on an experimental design item by which the user has actually run experiments or numerical analysis, chosen from multiple items of experimental design created by the optimization support apparatus.

12. The optimization support method according to claim 9, further comprising the steps of:
searching for a similar project that is similar to the target project from project information data stored in the project information storing unit; and
creating a preference model, based on design solution preference data specific to the target project and the similar project, stored in the design solution preference storing unit.
